(19) United States
(12) Patent Application Publication
(10) Pub. No.: US 2016/0077530 A1
(43) Pub. Date: Mar. 17, 2016

(54) SMART VALVE FOR CONTROLLING A PLUMBING FIXTURE

(71) Applicants: Michael T. Moran, Naas (IE); Charles Baron, Chandler, AZ (US)

(72) Inventors: Michael T. Moran, Naas (IE); Charles Baron, Chandler, AZ (US)

(21) Appl. No.: 14/485,203

(22) Filed: Sep. 12, 2014

(51) Int. Cl. G05D 7/06; G05B 19/416; F16K 31/00

(52) U.S. Cl. CPC G05D 7/0635; F16K 31/002; G05B 19/416; G05B 2219/41303

(57) ABSTRACT

A smart valve for controlling a plumbing fixture includes a control valve, a hydroelectric generator, and one or more sensors. The hydroelectric generator produces electrical power for the smart valve. The smart valve monitors sensor data from the sensors, evaluates the sensor data, and performs control actions in response to evaluating the sensor data. Control actions include restricting or shutting off water flow using the control valve. Control actions also include transmitting control messages to remote computing devices, for example to activate appliances or other home automation devices. The sensors may include a temperature sensor, a flow sensor, a proximity sensor, and/or a humidity sensor. The smart valve may shut off the water flow when a measured sensor value exceeds a predefined threshold value. The smart valve may be coupled inline between a plumbing system and a plumbing fixture. Other embodiments are described and claimed.

### BACKGROUND

Typically, plumbing fixtures such as showerheads, faucets, and spigots are mechanical devices. Thus, typical plumbing fixtures do not include any computer-controlled, connected, or otherwise “smart” capabilities. Additionally, typical plumbing fixtures may not interface with existing networked devices or other home automation systems.

In use, plumbing fixtures control the flow of water or other fluids. Because the typical plumbing fixture is a mechanical device, such control is generally manual. That is, plumbing fixtures are generally operated by a user of the plumbing fixture to control the flow pattern, temperature, and amount of water or other liquid delivered by the plumbing fixture. However, improper or inadvertent operation of the plumbing fixture may cause scalding, use a greater amount of fluid than required, and/or otherwise cause undesirable results.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified schematic diagram of at least one embodiment of a system for controlling water flow in a plumbing fixture;

FIG. 2 is a simplified block diagram of at least one embodiment of a system for controlling water flow in a plumbing fixture;

FIG. 3 is a simplified block diagram of at least one embodiment of an environment that may be established by a smart valve of the systems of FIGS. 1 and 2;

FIG. 4 is a simplified flow diagram of at least one embodiment of a method for controlling water flow that may be executed by the smart valve of the systems of FIGS. 1-3; and

FIG. 5 is a simplified flow diagram of at least one embodiment of another method for controlling water flow that may be executed by the smart valve of the systems of FIGS. 1-3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

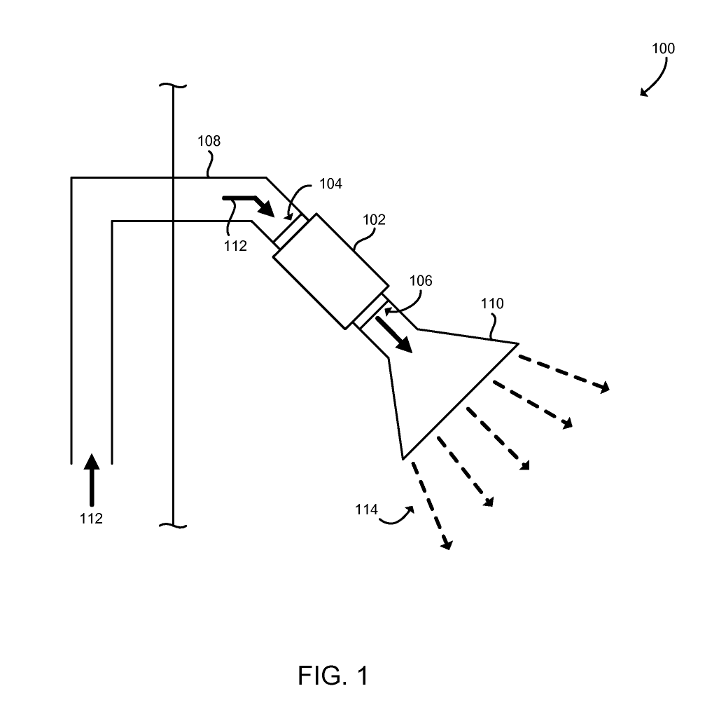

Referring now to FIG. 1, in an illustrative embodiment, a system 100 for controlling water flow in a plumbing fixture includes a smart valve 102, a plumbing system 108, and a plumbing fixture 110. The smart valve 102 includes a body having an inlet 104 and an outlet 106 at either end. The inlet 104 is configured to attach to the plumbing system 108, such as a household plumbing system. For example, the inlet 104 may include threading or other mechanical features configured to receive or otherwise attach to a hose, pipe, or other component of the plumbing system 108. Similarly, the outlet 106 is configured to attach to a plumbing fixture 110. The outlet 106 may also include threading or other mechanical features configured to receive or otherwise attach to the plumbing fixture 110 (or to an intermediate hose, pipe, or other component). When assembled, the smart valve 102 is positioned inline between the plumbing system 108 and the plumbing fixture 110. In the illustrative embodiment, the plumbing fixture 110 is an indoor showerhead. However, the plumbing fixture 110 may be embodied as any plumbing fixture that may be used with the plumbing system 108, such as a bathtub faucet, a sink faucet, a kitchen sprayer, or an outdoor spigot. In use, a user may activate water flow and select water temperature using a conventional supply valve handle or knob (not shown). When the supply valve is opened, water flow 112 flows through the plumbing system 108 and into the inlet 104 of the smart valve 102. As further described below, the smart valve 102 may allow the water flow 112 to flow out of the outlet 106 to the plumbing fixture 110. The plumbing fixture 110 produces water flow 114 for use by the user, in the illustrative example for showering.

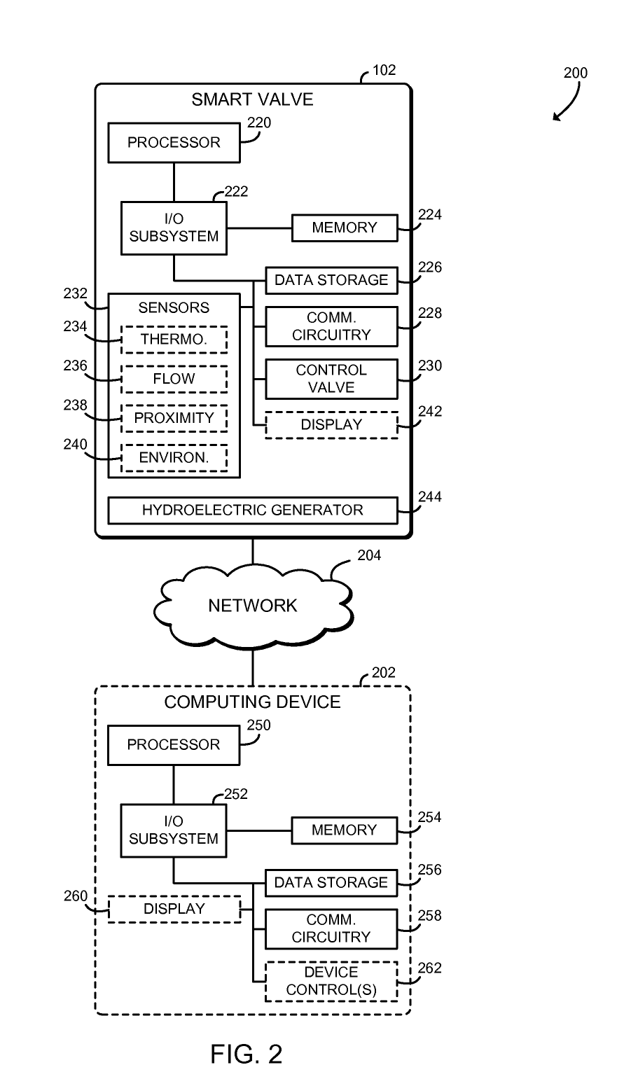

Referring now to FIG. 2, in an illustrative embodiment, a system 200 for controlling water flow 114 in the plumbing fixture 110 includes the smart valve 102 and, in some embodiments, one or more computing devices 202 in communication over a network 204. In use, as described in more detail below, the smart valve 102 monitors sensor data received from one or more sensors integrated in the smart valve 102. The smart valve 102 evaluates the sensor data and performs control actions based on the evaluation of the sensor data. For example, the smart valve 102 may monitor the water temperature and shut off the water flow 114 if the temperature is too high. In some embodiments, the smart valve 102 may transmit control messages to one or more of the remote computing devices 202, for example to activate home automation processes when appropriate. The smart valve 102 uses a hydroelectric generator to generate power using the supplied water flow 112, and thus may be installed in an existing plumbing system 108 without an external electric power connection. By performing “smart” monitoring and control at the plumbing fixture 110, the smart valve 102 may improve safety (for example, by reducing the risk of scalding). The smart valve 102 may also improve efficiency and/or reduce costs by restricting water flow or by controlling remote home automation devices.

The smart valve 102 may be embodied as any type of home automation device capable of performing the functions described herein, including, without limitation, an embedded computing device, a distributed computing system, a microcontroller-based system, a processor-based system, and/or a consumer electronic device. As shown in FIG. 1, the smart valve 102 illustratively includes a processor 220, an input/output subsystem 222, a memory 224, a data storage device 226, and communication circuitry 228. Of course, the smart valve 102 may include other or additional components, such as those commonly found in a plumbing valve (e.g., valves, actuators, or various other input/output devices), in other embodiments. Additionally, in some embodiments, one or more of the illustrative components may be incorporated in, or otherwise form a portion of, another component. For example, the memory 224, or portions thereof, may be incorporated in one or more processor 220 in some embodiments.

The processor 220 may be embodied as any type of processor capable of performing the functions described herein. The processor 220 may be embodied as a single or multi-core processor(s), digital signal processor, microcontroller, or other processor or processing/controlling circuit. Similarly, the memory 224 may be embodied as any type of volatile and/or non-volatile memory or data storage capable of performing the functions described herein. In operation, the memory 224 may store various data and software used during operation of the smart valve 102 such as operating systems, applications, programs, libraries, and drivers. The memory 224 is communicatively coupled to the processor 220 via the I/O subsystem 222, which may be embodied as circuitry and/or components to facilitate input/output operations with the processor 220, the memory 224, and other components of the smart valve 102. For example, the I/O subsystem 222 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 222 may form a portion of a system-on-a-chip (SoC) and be incorporated, along with the processor 220, the memory 224, and other components of the smart valve 102, on a single integrated circuit chip.

The data storage device 226 may be embodied as any type of device or devices configured for short-term or long-term storage of data such as, for example, memory devices and circuits, memory cards, hard disk drives, solid-state drives, or other data storage devices. The communication circuitry 228 of the smart valve 102 may be embodied as any communication circuit, device, or collection thereof, capable of enabling communications between the smart valve 102, the computing device(s) 202, and/or other remote devices over the network 204. The communication circuitry 228 may be configured to use any one or more communication technology (e.g., wired or wireless communications) and associated protocols (e.g., Ethernet, Bluetooth®, Wi-Fi®, WiMAX, 3G, 4G, etc.) to effect such communication.

The smart valve 102 further includes a control valve 230 and one or more sensors 232. The control valve 230 may be embodied as any electronically controllable valve or collection of valves that may restrict or shut off the water flow 114 through the smart valve 102. For example, the control valve 230 may be embodied as a diaphragm valve, a ball valve, a butterfly valve, a needle valve, a solenoid valve, or any combination of those valves.

The sensors 232 may include any sensors capable of monitoring the water flow 112, the water flow 114, and/or the local environment of the smart valve 102. For example, the sensors 232 may include a temperature sensor 234, a flow sensor 236, a proximity sensor 238, and/or an environmental humidity sensor 240. The temperature sensor 234 may be embodied as a digital thermometer or other sensor capable of measuring the temperature of the water flow 112, 114. The flow sensor 236 may be embodied as any flow meter, pressure gauge, or other sensor capable of measuring or deriving the flow rate of the water flow 112, 114. The proximity sensor 238 may be embodied as an infrared proximity sensor, ultrasonic proximity sensor, rangefinder, or any other sensor capable of determining the distance between the smart valve 102 and another object. The environmental humidity sensor 240 may be capable of measuring the relative and/or absolute humidity of the environment of the smart valve 102.

Additionally, in some embodiments, the smart valve 102 may include a display 242. The display 242 may be embodied as any type of display capable of displaying digital information such as a liquid crystal display (LCD), a light emitting diode (LED) display, a plasma display, a cathode ray tube (CRT), or other type of display device. The display 242 may be integrated in the body of the smart valve 102, or may be externally attached or otherwise coupled to the smart valve 102. For example, the display 242 may be included in a shower surround used with the smart valve 102, and the smart valve 102 may provide data to the display 242 using one or more wired or wireless links.

The smart valve 102 further includes a hydroelectric generator 244. The hydroelectric generator 244 converts kinetic energy of the water flow 112 into electrical energy usable by the other components of the smart valve 102. The hydroelectric generator 244 may be embodied as or otherwise include a dynamo, an inline turbine, and/or any other components capable of generating electrical power from the kinetic energy of the water flow 112.

The computing device 202 may be configured to provide home automation services in response to control messages from the smart valve 102. The computing device 202 may be embodied as any type of computation or computer device, or collection of computing devices, capable of performing the functions described herein, including, without limitation, a computer, a mobile computing device, an embedded computing device, a smart appliance, a home automation device, a multiprocessor system, a network appliance, a web appliance, a distributed computing system, a processor-based system, and/or a consumer electronic device. Illustratively, the computing device 202 includes a processor 250, an I/O subsystem 252, a memory 254, a data storage device 256, communication circuitry 258, in some embodiments a display 260, and/or other components and devices commonly found in a computer or similar computing device. Those individual components of the computing device 202 may be similar to the corresponding components of the smart valve 102, the description of which is applicable to the corresponding components of the computing device 202 and is not repeated herein so as not to obscure the present disclosure.

The computing device 202 may further include one or more device controls 262. Each device control 262 may be embodied as any adapter, controller, control signal, or other component capable of interfacing with and/or controlling an external device. For example, the device controls 262 may allow the computing device 202 to control various appliances such as heating ventilation and air conditioning (HVAC) systems, furnaces, thermostats, water heaters, exhaust fans, or other home appliances. Additionally, although illustrated as including one computing device 202, it should be understood that in some embodiments, the system 200 may include many computing devices 202.

As discussed in more detail below, the smart valve 102 and the computing device 202 may be configured to transmit and receive data with each other and/or other devices of the system 200 over the network 204. The network 204 may be embodied as any number of various wired and/or wireless networks. For example, the network 204 may be embodied as, or otherwise include, a wired or wireless local area network (LAN), a wired or wireless wide area network (WAN), a cellular network, and/or a publicly-accessible, global network such as the Internet. As such, the network 204 may include any number of additional devices, such as additional computers, routers, and switches, to facilitate communications among the devices of the system 200.

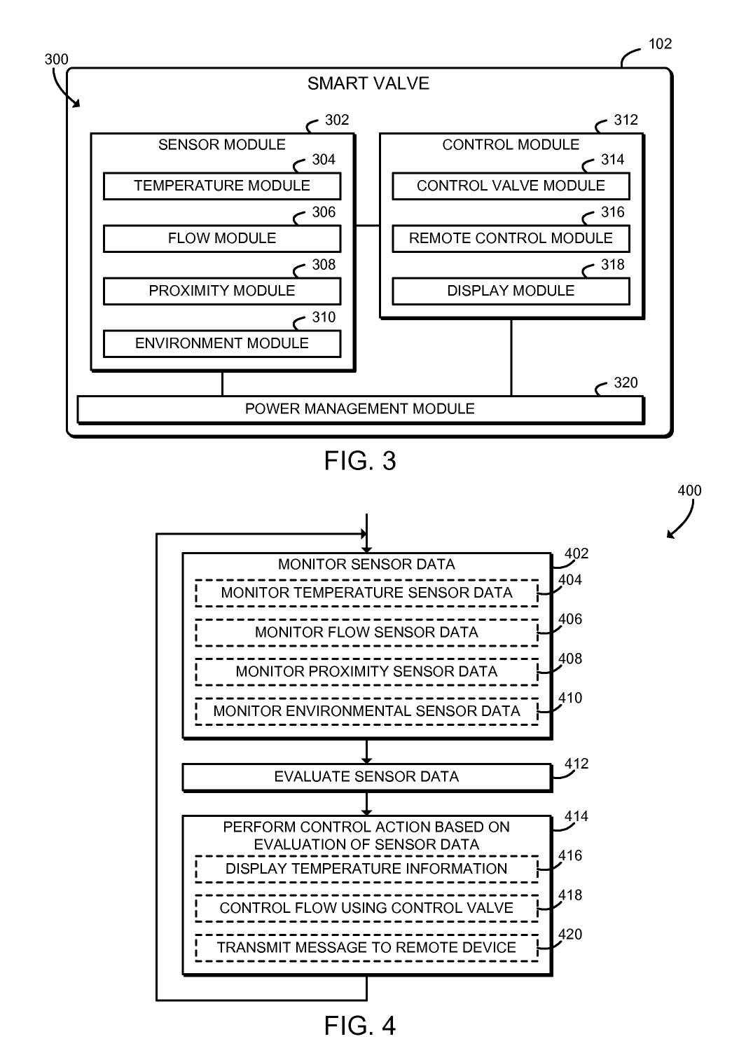

Referring now to FIG. 3, in an illustrative embodiment, the smart valve 102 establishes an environment 300 during operation. The illustrative environment 300 includes a sensor module 302, a control module 312, and a power management module 320. The various modules of the environment 300 may be embodied as hardware, firmware, software, or a combination thereof. For example the various modules, logic, and other components of the environment 300 may form a portion of, or otherwise be established by, the processor 220 and/or other hardware components of the smart valve 102.

The sensor module 302 is configured to monitor sensor data from the sensors 232. For example, the sensor module 302 may monitor sensor data from the temperature sensor 234, the flow sensor 236, the proximity sensor 238, and/or the environmental humidity sensor 240. In some embodiments, those functions may be performed by one or more sub-modules, such as a temperature module 304, a flow module 306, a proximity module 308, and/or an environment module 310.

The control module 312 is configured to evaluate the sensor data and perform one or more control actions based on evaluating the sensor data. The control module 312 may convert or otherwise transform the sensor data received from the sensor module 302 into one or more values usable to control the smart valve 102 (e.g., temperature values, flow values, proximity values, or humidity values). The control module 312 may display one or more of those values to the user, for example by displaying the temperature value on the display 242. The control module 312 may evaluate the sensor data by comparing measured values derived from the sensor data against one or more predefined thresholds. In some embodiments, the control module 312 may adjust the control valve 230 based on the evaluation of the sensor data. Additionally or alternatively, in some embodiments the control module 312 may transmit a control message to a remote computing device 202 based on the evaluation of the sensor data. In some embodiments, those functions may be performed by one or more sub-modules, such as a control valve module 314, a remote control module 316, and/or a display module 318.

The power management module 320 is configured to generate electrical power for the smart valve 102 using the hydroelectric generator 244. The power management module 320 may supply electrical power to all of the components of the smart valve 102, including the sensor module 302 and/or the control module 312. Thus, the power management module 320 may provide electrical power whenever the smart valve 102 is active.

Referring now to FIG. 4, in use, the smart valve 102 may execute a method 400 for controlling the water flow 114 through the plumbing fixture 110. The method 400 begins with block 402, in which the smart valve 102 monitors sensor data from the sensors 232. The smart valve 102 may monitor the sensor data at any time, for example continuously, periodically, or responsively, and use any technique for monitoring the sensor data, such as periodically polling the sensors 232 or monitoring for interrupts from the sensors 232. The smart valve 102 may record some or all of the sensor data for future analysis. In some embodiments, in block 404 the smart valve 102 may monitor the temperature sensor 234 for temperature sensor data. In some embodiments, in block 406 the smart valve 102 may monitor the flow sensor 236 for flow sensor data. In some embodiments, in block 408 the smart valve 102 may monitor the proximity sensor 238 for proximity sensor data. In some embodiments, in block 410 the smart valve 102 may monitor the environmental humidity sensor 240 for humidity sensor data.

In block 412, the smart valve 102 evaluates the sensor data. The smart valve 102 may, for example, determine one or more measured values as a function of the sensor data. For example, the smart valve 102 may determine a temperature value, a flow value, a water usage value, a proximity value, and/or a humidity value. The smart valve 102 may also evaluate the sensor data by comparing measured values to predetermined threshold values, such as maximum temperature, maximum water usage, and/or maximum humidity values. In some embodiments, the smart valve 102 may evaluate the sensor data by analyzing the sensor data to identify usage patterns.

In block 414, the smart valve 102 performs one or more control actions based on the evaluation of the sensor data. The control actions may include any command, signal, output, or other operation that affects the water flow 114, the physical environment of the smart valve 102, and/or any of the remote computing devices 202. In some embodiments, in block 416 the smart valve 102 may display temperature information to the user. For example, the smart valve 102 may display a temperature value using the display 242, and/or may transmit the temperature value to a remote computing device 202 for display to the user. In some embodiments, in block 418, the smart valve 102 may control the water flow 114 using the control valve 230. The smart valve 102 may completely open or completely close the control valve 230 to provide the water flow 114 or to shut off the water flow 114. In some embodiments, the smart valve 102 may partially open or close the control valve 230 to control the water flow 114. In some embodiments, in block 420 the smart valve 102 may transmit a control message to a remote computing device 202. For example, the smart valve 102 may transmit an activation message to the computing device 202 to activate an appliance such as an HVAC system or a water heater.

After performing the control action, the method 400 loops back to block 402 to continue monitoring sensor data and performing control actions. Additionally, although illustrated as being performed sequentially, it should be understood that the operations of the method 400 may be performed in any sequence. Further, some or all of the operations of the method 400 may be performed concurrently, simultaneously, or otherwise in parallel by the smart valve 102.

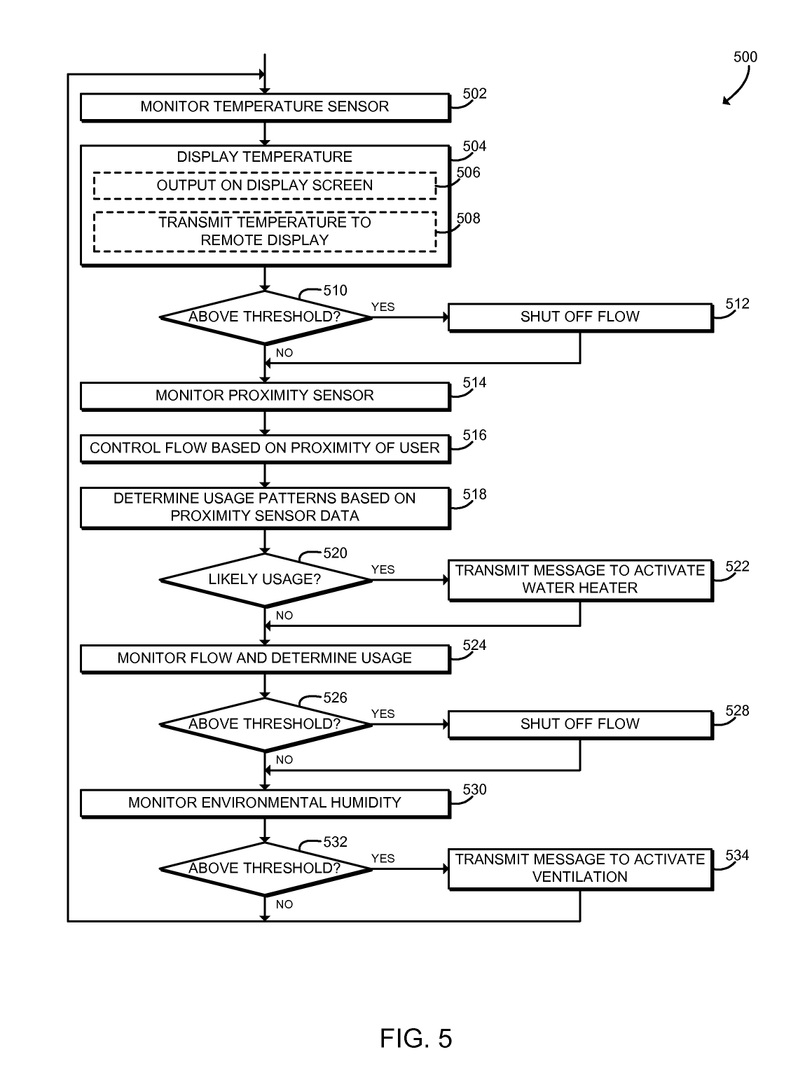

Referring now to FIG. 5, a more detailed embodiment of a method 500 for controlling the water flow 114 through the plumbing fixture 110 is shown. The various operations of the method 500 may be performed as a part of or otherwise in combination with the method 400. The method 500 begins with block 502, in which the smart valve 102 monitors the temperature sensor 234 for temperature sensor data. The smart valve 102 may use any technique to monitor the temperature sensor 234, such as polling the temperature sensor 234 or monitoring for interrupts from the temperature sensor 234. The smart valve 102 may determine a temperature value (e.g., a number of degrees Fahrenheit and/or Celsius) based on the sensor data received from the temperature sensor 234.

In block 504, the smart valve 102 displays the temperature value to the user. The smart valve 102 may use any technique to display a human-readable temperature value or other indication of the temperature value (e.g., color coding). In some embodiments, in block 506, the smart valve 102 may display the temperature value or other indication of the temperature value using the display 242. In some embodiments, in block 508 the smart valve 102 may transmit the temperature value to a remote computing device 202 for display to the user. The computing device 202 may display the temperature value, for example, using the display 260.

In block 510, the smart valve 102 determines whether the measured temperature value exceeds a predefined threshold temperature value. The threshold temperature value may be defined as a maximum comfortable and/or safe water temperature, allowing the smart valve 102 to reduce the risk of scalding. If the measured temperature value does not exceed the threshold temperature value, the method 500 advances to block 514, described below. If the measured temperature value exceeds the threshold temperature value, the method 500 branches to block 512. In block 512, the smart valve 102 shuts off the water flow 114 using the control valve 230. The smart valve 102 may generate a control signal, transmit a control command, or otherwise actuate the control valve 230 to shut off the water flow 114. Shutting off the water flow 114 may protect the user from excessively hot water. After shutting off the water flow 114, the method 500 advances to block 514.

In block 514, the smart valve 102 monitors the proximity sensor 238 for proximity sensor data. The smart valve 102 may use any technique to monitor the proximity sensor 238, such as polling the proximity sensor 238 or monitoring for interrupts from the proximity sensor 238. The smart valve 102 may determine a proximity value (e.g., distance from the smart valve 102 to an external object) based on the sensor data received from the proximity sensor 238.

In block 516, the smart valve 102 controls the water flow 114 using the control valve 230 based on the proximity value. The smart valve 102 may use any appropriate control technique or algorithm. For example, the smart valve 102 may partially open or close the control valve 230 to control the water flow 114 provided to the user based on the measured distance to the user. For example, higher flow rate and/or pressure may be provided for a user positioned further away from the smart valve 102. Additionally or alternatively, in some embodiments, the smart valve 102 may reduce the flow rate and/or pressure when the user moves away from the smart valve 102 (for example, to lather up) and may increase the flow rate and/or pressure when the user moves closer to the smart valve 102 (for example, to rinse off).

In block 518, the smart valve 102 determines usage patterns based on the proximity sensor data. A usage pattern may identify typical times of day at which the user is near the smart valve 102 or otherwise using the smart valve 102 and/or the plumbing fixture 110. For example, the smart valve 102 may determine that the user typically uses the plumbing fixture 110 at about 6:00 a.m. every day.

In block 520, the smart valve 102 determines whether the smart valve 102 is currently likely to be used based on the usage patterns. Continuing the previous example, if the user typically uses the plumbing fixture 110 at 6:00 a.m., the smart valve 102 may determine that the smart valve 102 is currently likely to be used at some time shortly before 6:00 a.m. (e.g., 5:30 a.m.). If usage is not likely, the method 500 advances to block 524, described below. If usage is likely, the method 500 branches to block 522.

In block 522, the smart valve 102 transmits a message to activate a water heater, in order to prepare for use of the plumbing fixture 110. The smart valve 102 may transmit the message to one or more remote computing devices 202 capable of controlling the water heater. For example, the smart valve 102 may transmit a control message to a home automation device. By activating the water heater based on usage patterns, the smart valve 102 may increase efficiency and reduce costs. After activating the water heater, the method 500 advances to block 524.

In block 524, the smart valve 102 monitors the flow sensor 236 for flow sensor data. The smart valve 102 may use any technique to monitor the flow sensor 236, such as polling the flow sensor 236 or monitoring for interrupts from the flow sensor 236. The smart valve 102 may determine a flow value (e.g., a number of gallons per minute or liters per minute) based on the sensor data received from the flow sensor 236. Additionally or alternatively, the smart valve 102 may determine a water usage value (e.g., a total number of gallons or liters) based on the sensor data received from the flow sensor 236.

In block 526, the smart valve 102 determines whether the measured water usage value exceeds a predefined threshold water usage value. If the measured water usage value does not exceed the threshold water usage value, the method 500 advances to block 530, described below. If the measured water usage value exceeds the threshold water usage value, the method 500 branches to block 528. In block 528, the smart valve 102 shuts off the water flow 114 using the control valve 230. As described above, the smart valve 102 may generate a control signal, transmit a control command, or otherwise actuate the control valve 230 to shut off the water flow 114. Shutting off the water flow 114 may conserve water and reduce costs. After shutting off the water flow 114, the method 500 advances to block 530.

In block 530, the smart valve 102 monitors the environmental humidity sensor 240 for humidity sensor data. The smart valve 102 may use any technique to monitor the environmental humidity sensor 240, such as polling the environmental humidity sensor 240 or monitoring for interrupts from the environmental humidity sensor 240. The smart valve 102 may determine a humidity value (e.g., a percent humidity) based on the sensor data received from the environmental humidity sensor 240.

In block 532, the smart valve 102 determines whether the measured humidity value exceeds a predefined threshold humidity value. If the measured humidity value does not exceed the threshold water usage value, the method 500 loops back to block 502 to continue monitoring the sensors 232. If the measured humidity value exceeds the threshold humidity value, the method 500 branches to block 534. In block 534, the smart valve 102 transmits a message to activate ventilation, in order reduce humidity in the physical environment of the smart valve 102. The smart valve 102 may transmit the message to one or more remote computing devices 202 capable of controlling an HVAC system, an exhaust fan, or otherwise capable of controlling ventilation. For example, the smart valve 102 may transmit a control message to a home automation device. After activating the ventilation, the method 500 loops back to block 502 to continue monitoring the sensors 232.

It should be appreciated that although the smart valve 102 has been shown and described above as an aftermarket or “retro-fit” device capable of being attached to an outlet of an existing plumbing system 108, the smart valve 102 may also be incorporated into the plumbing system 108 itself in other embodiments. For example, the smart valve 102 may be attached in-line with the plumbing system 108 and located within the walls of a structure or at an origination source of water (e.g., at the water heater). Such smart valves 102 may be used in addition to the smart valves 102 coupled to the outlet of the existing plumbing system 108 discussed above.

### EXAMPLES

Illustrative examples of the technologies disclosed herein are provided below. An embodiment of the technologies may include any one or more, and any combination of, the examples described below.

Example 1 includes a smart valve for controlling water flow in a plumbing fixture, the smart valve comprising a body having an inlet and an outlet, wherein the inlet is configured to attach to a plumbing system and the outlet is configured to attach to the plumbing fixture; a control valve selectively controllable to restrict water flow from the inlet to the outlet; a power management module to generate electrical power for the smart valve using a hydroelectric generator of the smart valve; a sensor module to monitor sensor data from one or more sensors of the smart valve; and a control module to (i) evaluate the sensor data and (ii) perform a control action in response to evaluation of the sensor data.

Example 2 includes the subject matter of Example 1, and wherein to evaluate the sensor data comprises to (i) determine a measured value as a function of the sensor data and (ii) determine whether the measured value has a predefined relationship to a threshold value; and to perform the control action comprises to perform the control action in response to a determination that the measured value has the predefined relationship to the threshold value.

Example 3 includes the subject matter of any of Examples 1 and 2, and wherein to perform the control action comprises to actuate the control valve to restrict the water flow.

Example 4 includes the subject matter of any of Examples 1-3, and wherein to perform the control action comprises to transmit a control message to a remote computing device.

Example 5 includes the subject matter of any of Examples 1-4, and wherein the one or more sensors of the computing device comprises a temperature sensor.

Example 6 includes the subject matter of any of Examples 1-5, and wherein to perform the control action comprises to display a temperature value as a function of the sensor data.

Example 7 includes the subject matter of any of Examples 1-6, and wherein to display the temperature value comprises to display the temperature value using a display coupled to the smart valve.

Example 8 includes the subject matter of any of Examples 1-7, and wherein to display the temperature value comprises to transmit the temperature value to a remote computing device.

Example 9 includes the subject matter of any of Examples 1-8, and wherein to evaluate the sensor data comprises to (i) determine a temperature value as a function of the sensor data and (ii) determine whether the temperature value has a predefined relationship to a threshold temperature value; and to perform the control action comprises to actuate a control valve of the smart valve to shut off the water flow in response to a determination that the temperature value has the predefined relationship to the threshold temperature value.

Example 10 includes the subject matter of any of Examples 1-9, and wherein the one or more sensors of the computing device comprises a flow sensor.

Example 11 includes the subject matter of any of Examples 1-10, and wherein to evaluate the sensor data comprises to (i) determine a water usage value as a function of the sensor data and (ii) determine whether the water usage value has a predefined relationship to a threshold water usage value; and to perform the control action comprises to actuate the control valve to shut off the water flow in response to a determination that the water usage value has the predefined relationship to the threshold water usage value.

Example 12 includes the subject matter of any of Examples 1-11, and wherein the one or more sensors of the computing device comprises a proximity sensor.

Example 13 includes the subject matter of any of Examples 1-12, and wherein to evaluate the sensor data comprises to determine a proximity value as a function of the sensor data; and to perform the control action comprises to actuate the control valve to restrict the water flow as a function of the proximity value.

Example 14 includes the subject matter of any of Examples 1-13, and wherein to evaluate the sensor data comprises to determine a usage pattern as a function of the sensor data, wherein the usage pattern identifies a likely usage time of day for the smart valve; and to perform the control action comprises to transmit a control message to a remote computing device prior to the likely usage time of day.

Example 15 includes the subject matter of any of Examples 1-14, and wherein to transmit the control message comprises to transmit an activation message to a smart water heater coupled to the plumbing system.

Example 16 includes the subject matter of any of Examples 1-15, and wherein the one or more sensors of the computing device comprises an environmental humidity sensor.

Example 17 includes the subject matter of any of Examples 1-16, and wherein to evaluate the sensor data comprises to (i) determine a humidity value as a function of the sensor data and (ii) determine whether the humidity value has a predefined relationship to a threshold humidity value; and to perform the control action comprises to transmit a control message to a remote computing device in response to a determination that the humidity value has the predefined relationship to the threshold humidity value.

Example 18 includes the subject matter of any of Examples 1-17, and wherein to transmit the control message comprises to transmit an activation message to a ventilation system.

Example 19 includes the subject matter of any of Examples 1-18, and wherein the plumbing fixture comprises a showerhead.

Example 20 includes a method for controlling water flow in a plumbing fixture, the method comprising generating, by a smart valve coupled between a plumbing system and the plumbing fixture, electrical power for the smart valve using a hydroelectric generator of the smart valve; monitoring, by a smart valve, sensor data from one or more sensors of the smart valve; evaluating, by the smart valve, the sensor data; and performing, by the smart valve, a control action in response to evaluating the sensor data.

Example 21 includes the subject matter of Example 20, and wherein evaluating the sensor data comprises (i) determining a measured value as a function of the sensor data and (ii) determining whether the measured value has a predefined relationship to a threshold value; and performing the control action comprises performing the control action in response to determining the measured value has the predefined relationship to the threshold value.

Example 22 includes the subject matter of any of Examples 20 and 21, and wherein performing the control action comprises actuating a control valve of the smart valve to restrict water flow to the plumbing fixture.

Example 23 includes the subject matter of any of Examples 20-22, and wherein performing the control action comprises transmitting a control message to a remote computing device.

Example 24 includes the subject matter of any of Examples 20-23, and wherein monitoring the sensor data comprises monitoring sensor data from a temperature sensor of the computing device.

Example 25 includes the subject matter of any of Examples 20-24, and wherein performing the control action comprises displaying a temperature value as a function of the sensor data.

Example 26 includes the subject matter of any of Examples 20-25, and wherein displaying the temperature value comprises displaying the temperature value using a display coupled to the smart valve.

Example 27 includes the subject matter of any of Examples 20-26, and wherein displaying the temperature value comprises transmitting the temperature value to a remote computing device.

Example 28 includes the subject matter of any of Examples 20-27, and wherein evaluating the sensor data comprises (i) determining a temperature value as a function of the sensor data and (ii) determining whether the temperature value has a predefined relationship to a threshold temperature value; and performing the control action comprises actuating a control valve of the smart valve to shut off water flow to the plumbing fixture in response to determining the temperature value has the predefined relationship to the threshold temperature value.

Example 29 includes the subject matter of any of Examples 20-28, and wherein monitoring the sensor data comprises monitoring sensor data from a flow sensor of the computing device.

Example 30 includes the subject matter of any of Examples 20-29, and wherein evaluating the sensor data comprises (i) determining a water usage value as a function of the sensor data and (ii) determining whether the water usage value has a predefined relationship to a threshold water usage value; and performing the control action comprises actuating a control valve of the smart valve to shut off water flow to the plumbing fixture in response to determining the water usage value has the predefined relationship to the threshold water usage value.

Example 31 includes the subject matter of any of Examples 20-30, and wherein monitoring the sensor data comprises monitoring sensor data from a proximity sensor of the computing device.

Example 32 includes the subject matter of any of Examples 20-31, and wherein evaluating the sensor data comprises determining a proximity value as a function of the sensor data; and performing the control action comprises actuating a control valve of the smart valve to restrict water flow to the plumbing fixture as a function of the proximity value.

Example 33 includes the subject matter of any of Examples 20-32, and wherein evaluating the sensor data comprises determining a usage pattern as a function of the sensor data, wherein the usage pattern identifies a likely usage time of day for the plumbing fixture; and performing the control action comprises transmitting a control message to a remote computing device prior to the likely usage time of day.

Example 34 includes the subject matter of any of Examples 20-33, and wherein transmitting the control message comprises transmitting an activation message to a smart water heater coupled to the plumbing system.

Example 35 includes the subject matter of any of Examples 20-34, and wherein monitoring the sensor data comprises monitoring sensor data from an environmental humidity sensor of the computing device.

Example 36 includes the subject matter of any of Examples 20-35, and wherein evaluating the sensor data comprises (i) determining a humidity value as a function of the sensor data and (ii) determining whether the humidity value has a predefined relationship to a threshold humidity value; and performing the control action comprises transmitting a control message to a remote computing device in response to determining the humidity value has the predefined relationship to the threshold humidity value.

Example 37 includes the subject matter of any of Examples 20-36, and wherein transmitting the control message comprises transmitting an activation message to a ventilation system.

Example 38 includes the subject matter of any of Examples 20-37, and wherein the plumbing fixture comprises a showerhead.

Example 39 includes a computing device comprising a processor; and a memory having stored therein a plurality of instructions that when executed by the processor cause the computing device to perform the method of any of Examples 20-38.

Example 40 includes one or more machine readable storage media comprising a plurality of instructions stored thereon that in response to being executed result in a computing device performing the method of any of Examples 20-38.

Example 41 includes a computing device comprising means for performing the method of any of Examples 20-38.

Example 42 includes a smart valve for controlling water flow in a plumbing fixture, the smart valve comprising means for generating, by the smart valve coupled between a plumbing system and the plumbing fixture, electrical power for the smart valve using a hydroelectric generator of the smart valve; means for monitoring sensor data from one or more sensors of the smart valve; means for evaluating the sensor data; and means for performing a control action in response to evaluating the sensor data.

Example 43 includes the subject matter of Example 42, and wherein the means for evaluating the sensor data comprises means for (i) determining a measured value as a function of the sensor data and (ii) determining whether the measured value has a predefined relationship to a threshold value; and the means for performing the control action comprises means for performing the control action in response to determining the measured value has the predefined relationship to the threshold value.

Example 44 includes the subject matter of any of Examples 42 and 43, and wherein the means for performing the control action comprises means for actuating a control valve of the smart valve to restrict water flow to the plumbing fixture.

Example 45 includes the subject matter of any of Examples 42-44, and wherein the means for performing the control action comprises means for transmitting a control message to a remote computing device.

Example 46 includes the subject matter of any of Examples 42-45, and wherein the means for monitoring the sensor data comprises means for monitoring sensor data from a temperature sensor of the computing device.

Example 47 includes the subject matter of any of Examples 42-46, and wherein the means for performing the control action comprises means for displaying a temperature value as a function of the sensor data.

Example 48 includes the subject matter of any of Examples 42-47, and wherein the means for displaying the temperature value comprises means for displaying the temperature value using a display coupled to the smart valve.

Example 49 includes the subject matter of any of Examples 42-48, and wherein the means for displaying the temperature value comprises means for transmitting the temperature value to a remote computing device.

Example 50 includes the subject matter of any of Examples 42-49, and wherein the means for evaluating the sensor data comprises means for (i) determining a temperature value as a function of the sensor data and (ii) determining whether the temperature value has a predefined relationship to a threshold temperature value; and the means for performing the control action comprises means for actuating a control valve of the smart valve to shut off water flow to the plumbing fixture in response to determining the temperature value has the predefined relationship to the threshold temperature value.

Example 51 includes the subject matter of any of Examples 42-50, and wherein the means for monitoring the sensor data comprises means for monitoring sensor data from a flow sensor of the computing device.

Example 52 includes the subject matter of any of Examples 42-51, and wherein the means for evaluating the sensor data comprises means for (i) determining a water usage value as a function of the sensor data and (ii) determining whether the water usage value has a predefined relationship to a threshold water usage value; and the means for performing the control action comprises means for actuating a control valve of the smart valve to shut off water flow to the plumbing fixture in response to determining the water usage value has the predefined relationship to the threshold water usage value.

Example 53 includes the subject matter of any of Examples 42-52, and wherein the means for monitoring the sensor data comprises means for monitoring sensor data from a proximity sensor of the computing device.

Example 54 includes the subject matter of any of Examples 42-53, and wherein the means for evaluating the sensor data comprises means for determining a proximity value as a function of the sensor data; and the means for performing the control action comprises means for actuating a control valve of the smart valve to restrict water flow to the plumbing fixture as a function of the proximity value.

Example 55 includes the subject matter of any of Examples 42-54, and wherein the means for evaluating the sensor data comprises means for determining a usage pattern as a function of the sensor data, wherein the usage pattern identifies a likely usage time of day for the plumbing fixture; and the means for performing the control action comprises means for transmitting a control message to a remote computing device prior to the likely usage time of day.

Example 56 includes the subject matter of any of Examples 42-55, and wherein the means for transmitting the control message comprises means for transmitting an activation message to a smart water heater coupled to the plumbing system.

Example 57 includes the subject matter of any of Examples 42-56, and wherein the means for monitoring the sensor data comprises means for monitoring sensor data from an environmental humidity sensor of the computing device.

Example 58 includes the subject matter of any of Examples 42-57, and wherein the means for evaluating the sensor data comprises means for (i) determining a humidity value as a function of the sensor data and (ii) determining whether the humidity value has a predefined relationship to a threshold humidity value; and the means for performing the control action comprises means for transmitting a control message to a remote computing device in response to determining the humidity value has the predefined relationship to the threshold humidity value.

Example 59 includes the subject matter of any of Examples 42-58, and wherein the means for transmitting the control message comprises means for transmitting an activation message to a ventilation system.

Example 60 includes the subject matter of any of Examples 42-59, and wherein the plumbing fixture comprises a showerhead.

1. A smart valve for controlling water flow in a plumbing fixture, the smart valve comprising:
a body having an inlet and an outlet, wherein the inlet is configured to attach to a plumbing system and the outlet is configured to attach to the plumbing fixture;
a control valve selectively controllable to restrict water flow from the inlet to the outlet;
a power management module to generate electrical power for the smart valve using a hydroelectric generator of the smart valve;
a sensor module to monitor sensor data from one or more sensors of the smart valve; and
a control module to: (i) evaluate the sensor data and (ii) perform a control action in response to evaluation of the sensor data.

2. The smart valve of claim 1, wherein:
to evaluate the sensor data comprises to (i) determine a measured value as a function of the sensor data and (ii) determine whether the measured value has a predefined relationship to a threshold value; and
to perform the control action comprises to perform the control action in response to a determination that the measured value has the predefined relationship to the threshold value.

3. The smart valve of claim 1, wherein to perform the control action comprises to actuate the control valve to restrict the water flow.

4. The smart valve of claim 1, wherein to perform the control action comprises to transmit a control message to a remote computing device.

5. The smart valve of claim 1, wherein:
the one or more sensors of the computing device comprises a temperature sensor; and
to perform the control action comprises to display a temperature value as a function of the sensor data.

6. The smart valve of claim 1, wherein:
the one or more sensors of the computing device comprises a temperature sensor;
to evaluate the sensor data comprises to (i) determine a temperature value as a function of the sensor data and (ii) determine whether the temperature value has a predefined relationship to a threshold temperature value; and
to perform the control action comprises to actuate a control valve of the smart valve to shut off the water flow in response to a determination that the temperature value has the predefined relationship to the threshold temperature value.

7. The smart valve of claim 1, wherein:
the one or more sensors of the computing device comprises a flow sensor;
to evaluate the sensor data comprises to (i) determine a water usage value as a function of the sensor data and (ii) determine whether the water usage value has a predefined relationship to a threshold water usage value; and
to perform the control action comprises to actuate the control valve to shut off the water flow in response to a determination that the water usage value has the predefined relationship to the threshold water usage value.

8. The smart valve of claim 1, wherein:
the one or more sensors of the computing device comprises a proximity sensor;
to evaluate the sensor data comprises to determine a proximity value as a function of the sensor data; and
to perform the control action comprises to actuate the control valve to restrict the water flow as a function of the proximity value.

9. The smart valve of claim 1, wherein:
the one or more sensors of the computing device comprises a proximity sensor;
to evaluate the sensor data comprises to determine a usage pattern as a function of the sensor data, wherein the usage pattern identifies a likely usage time of day for the smart valve; and
to perform the control action comprises to transmit a control message to a remote computing device prior to the likely usage time of day.

10. The smart valve of claim 1, wherein:
the one or more sensors of the computing device comprises an environmental humidity sensor;
to evaluate the sensor data comprises to (i) determine a humidity value as a function of the sensor data and (ii) determine whether the humidity value has a predefined relationship to a threshold humidity value; and
to perform the control action comprises to transmit a control message to a remote computing device in response to a determination that the humidity value has the predefined relationship to the threshold humidity value.

11. A method for controlling water flow in a plumbing fixture, the method comprising:
generating, by a smart valve coupled between a plumbing system and the plumbing fixture, electrical power for the smart valve using a hydroelectric generator of the smart valve;
monitoring, by a smart valve, sensor data from one or more sensors of the smart valve;
evaluating, by the smart valve, the sensor data; and
performing, by the smart valve, a control action in response to evaluating the sensor data.

12. The method of claim 11, wherein:
evaluating the sensor data comprises (i) determining a measured value as a function of the sensor data and (ii) determining whether the measured value has a predefined relationship to a threshold value; and
performing the control action comprises performing the control action in response to determining the measured value has the predefined relationship to the threshold value.

13. The method of claim 11, wherein performing the control action comprises actuating a control valve of the smart valve to restrict water flow to the plumbing fixture.

14. The method of claim 11, wherein performing the control action comprises transmitting a control message to a remote computing device.

15. The method of claim 11, wherein:
monitoring the sensor data comprises monitoring sensor data from a temperature sensor of the computing device;
evaluating the sensor data comprises (i) determining a temperature value as a function of the sensor data and (ii) determining whether the temperature value has a predefined relationship to a threshold temperature value; and
performing the control action comprises actuating a control valve of the smart valve to shut off water flow to the plumbing fixture in response to determining the temperature value has the predefined relationship to the threshold temperature value.

16. The method of claim 11, wherein:
monitoring the sensor data comprises monitoring sensor data from a flow sensor of the computing device;
evaluating the sensor data comprises (i) determining a water usage value as a function of the sensor data and (ii) determining whether the water usage value has a predefined relationship to a threshold water usage value; and
performing the control action comprises actuating a control valve of the smart valve to shut off water flow to the plumbing fixture in response to determining the water usage value has the predefined relationship to the threshold water usage value.

17. The method of claim 11, wherein:
monitoring the sensor data comprises monitoring sensor data from an environmental humidity sensor of the computing device;
evaluating the sensor data comprises (i) determining a humidity value as a function of the sensor data and (ii) determining whether the humidity value has a predefined relationship to a threshold humidity value; and
performing the control action comprises transmitting a control message to a remote computing device in response to determining the humidity value has the predefined relationship to the threshold humidity value.

18. One or more computer-readable storage media comprising a plurality of instructions that in response to being executed cause a smart valve to:
generate, by the smart valve coupled between a plumbing system and the plumbing fixture, electrical power for the smart valve using a hydroelectric generator of the smart valve;
monitor sensor data from one or more sensors of the smart valve;
evaluate the sensor data; and
perform a control action in response to evaluating the sensor data.

19. The one or more computer-readable storage media of claim 18, wherein:
to evaluate the sensor data comprises to (i) determine a measured value as a function of the sensor data and (ii) determine whether the measured value has a predefined relationship to a threshold value; and
to perform the control action comprises to perform the control action in response to determining the measured value has the predefined relationship to the threshold value.

20. The one or more computer-readable storage media of claim 18, wherein to perform the control action comprises to actuate a control valve of the smart valve to restrict water flow to the plumbing fixture.

21. The one or more computer-readable storage media of claim 18, wherein to perform the control action comprises to transmit a control message to a remote computing device.

22. The one or more computer-readable storage media of claim 18, wherein:
to monitor the sensor data comprises to monitor sensor data from a temperature sensor of the computing device;
to evaluate the sensor data comprises to (i) determine a temperature value as a function of the sensor data and (ii) determine whether the temperature value has a predefined relationship to a threshold temperature value; and
to perform the control action comprises to actuate a control valve of the smart valve to shut off water flow to the plumbing fixture in response to determining the temperature value has the predefined relationship to the threshold temperature value.

23. The one or more computer-readable storage media of claim 18, wherein:
to monitor the sensor data comprises to monitor sensor data from a flow sensor of the computing device;
to evaluate the sensor data comprises to (i) determine a water usage value as a function of the sensor data and (ii) determine whether the water usage value has a predefined relationship to a threshold water usage value; and
to perform the control action comprises to actuate a control valve of the smart valve to shut off water flow to the plumbing fixture in response to determining the water usage value has the predefined relationship to the threshold water usage value.

24. The one or more computer-readable storage media of claim 18, wherein:
to monitor the sensor data comprises to monitor sensor data from a proximity sensor of the computing device;
to evaluate the sensor data comprises to determine a proximity value as a function of the sensor data; and
to perform the control action comprises to actuate a control valve of the smart valve to restrict water flow to the plumbing fixture as a function of the proximity value.

25. The one or more computer-readable storage media of claim 18, wherein:
to monitor the sensor data comprises to monitor sensor data from an environmental humidity sensor of the computing device;
to evaluate the sensor data comprises to (i) determine a humidity value as a function of the sensor data and (ii) determine whether the humidity value has a predefined relationship to a threshold humidity value; and
to perform the control action comprises to transmit a control message to a remote computing device in response to determining the humidity value has the predefined relationship to the threshold humidity value.
